(19) United States
(12) Patent Application Publication
(10) Pub. No.: US 2018/0059306 A1
(43) Pub. Date: Mar. 1, 2018

(54) WEARABLE APPARATUS AND LIGHT GUIDE ELEMENT

(71) Applicant: Coretronic Corporation, Hsin-Chu (TW)

(72) Inventors: Haw-Woei Pan, Hsin-Chu (TW); Chih-Hsien Tsai, Hsin-Chu (TW); Chi-Tang Hsieh, Hsin-Chu (TW); Yi-Hsuang Weng, Hsin-Chu (TW)

(21) Appl. No.: 15/688,822

(22) Filed: Aug. 28, 2017

(30) Foreign Application Priority Data
Aug. 31, 2016 (CN) 201610784620.8

(51) Int. Cl. F21V 8/00; G02B 27/01; G02B 27/00; G02B 27/22

(52) U.S. Cl. CPC G02B 6/0028; G02B 27/0172; G02B 6/003; G02B 27/225; G02B 27/0081

(57) ABSTRACT

A light guide element of a wearable apparatus adapted to guide a light beam includes first and second light guide plates and a light splitting film. The first light guide plate has first and second surfaces, and a light entrance surface. The second light guide plate is disposed on the partial first surface and located on a transmission path of the light beam. The light splitting film is disposed between the partial first surface and the second light guide plate, and adjacent to the light entrance surface. The light splitting film is adapted to reflect a portion of the light beam and allow the partial light beam from the partial first surface to pass to the second light guide plate.

### CROSS-REFERENCE TO RELATED APPLICATION

THIS APPLICATION CLAIMS THE PRIORITY BENEFIT OF CN201610784620.8 FIELD ON 2016 Aug. 31. THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a display apparatus, and more particularly to a wearable apparatus having a light guide element.

### BACKGROUND OF THE INVENTION

Wearable apparatus is considered to be one of the electronic products with the most potential market growth after smart phone. Based on the different wearing types, wearable apparatuses would be divided into glasses type, watch type, dress type, wear type and stick type. In addition to allowing users to easily operate during the movement, the wearable apparatus further provides users with physiological information, personalized management and interaction with the situation via the data capturing about physical, health, environment and satellite positioning, thereby enhancing the convenience of the user's life. With the development of near eye display (NED), the applications of virtual reality (VR), mixed reality (MR) and augmented reality (AR) also increase. In the case of the glasses-type wearable apparatus, there are still problems such as having a dead angle in the viewing field and having bright-dark streaks in images.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One objective of the invention is to provide a wearable apparatus for improving the problem of uneven image brightness.

Another objective of the invention is to provide a light guide element capable being applied to a wearable apparatus to improve the problem of uneven image brightness.

In order to achieve one or a portion of or all of the objects or other objects, the invention provides a wearable apparatus, and the wearable apparatus includes at least one imaging assembly. The imaging assembly includes a display apparatus and a light guide element. The display apparatus is adapted to provide an image light beam. The light guide element is adapted to guide the image light beam. The light guide element includes a first light guide plate, a second light guide plate, a light splitting film, and a plurality of light splitting elements. The first light guide plate has a first surface, a second surface, and a light entrance surface. The second surface is opposite to the first surface, and the light entrance surface is connected between the first surface and the second surface. The light entrance surface is adapted to allow the image light beam to pass through. The second light guide plate is disposed on a part of the first surface of the first light guide plate, and located on a transmission path of the image light beam. The light splitting film is disposed between the second light guide plate and a part of the first surface of the first light guide plate, and adjacent to the light entrance surface. The light splitting film is adapted to reflect a portion of the image light beam, and is adapted to allow at least a portion of the image light beam from a part of the first surface of the first light guide plate to pass to the second light guide plate. The light splitting elements are intervally disposed in a region of the first light guide plate not being covered with the light splitting film. Each of the light splitting elements is connected between the first surface and the second surface. A first acute angle is formed between the second surface and a surface of each of the light splitting elements facing the light entrance surface. Each of the light splitting elements is adapted to allow a portion of the image light beam to pass through and reflect a portion of the image light beam. The image light beam is adapted to emit out from the second surface via reflection of the light splitting elements.

In order to achieve one or a portion of or all of the objects or other objects, the invention further provides a light guide element is adapted to guide a light beam. The light guide element includes a first light guide plate, a second light guide plate, a light splitting film, and a plurality of light splitting elements. The first light guide plate has a first surface, a second surface, and a light entrance surface. The second surface is opposite to the first surface, and the light entrance surface is connected between the first surface and the second surface. The light entrance surface is adapted to allow the light beam to pass through. The second light guide plate is disposed on a part of the first surface of the first light guide plate, and located on a transmission path of the light beam. The light splitting film is disposed between the second light guide plate and a part of the first surface of the first light guide plate, and adjacent to the light entrance surface. The light splitting film is adapted to reflect a portion of the light beam, and is adapted to allow at least a portion of the light beam from a part of the first surface of the first light guide plate to pass to the second light guide plate. The light splitting elements are intervally disposed in a region of the first light guide plate not being covered with the light splitting film. Each of the light splitting elements is connected between the first surface and the second surface. A first acute angle is formed between the second surface and a surface of each of the light splitting elements facing the light entrance surface. Each of the light splitting elements is adapted to allow a portion of the light beam to pass through and reflect a portion of the light beam. The light beam is adapted to emit out from the second surface via reflection of the light splitting elements.

In summary, in the light guide element according to the embodiment of the invention, the second light guide plate adjacent to the light entrance surface is additionally disposed on the first light guide plate, and the light splitting film is disposed between the first light guide plate and the second light guide plate; therefore, in the light beam (e.g., an image light beam) entering into the light guide element, a portion of the image light beam may be reflected in the first light guide plate and a portion of the image light beam may pass through the first light guide plate and the light splitting film to enter into the second light guide plate and may be then reflected back into the first light guide plate via the second light guide plate. Due to the increased number of transmission path(s) of the image light beam, the filling ratio of the light receiving surface of the light splitting elements may be increased when the image light beam is transmitted to the light splitting elements; thus, the problem that the imaging of the prior art has a uneven image brightness due to bright-dark streaks is improved or solved. The wearable apparatus having the light guide element of the embodiment of the invention may improve the problem of uneven image brightness of the prior art.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a wearable apparatus in accordance with an embodiment of the invention;

FIG. 2 is a schematic view of an imaging assembly in accordance with an embodiment of the invention;

FIG. 3 is a schematic view of an imaging assembly in accordance with another embodiment of the invention;

FIG. 4 is a schematic view of an image light beam travelling in a first light guide plate, a second light guide plate, and a light splitting film in accordance with an embodiment of the invention;

FIG. 5 is a schematic view of a light guide element in accordance with an embodiment of the invention; and

FIG. 6 is a schematic view of an imaging assembly in accordance with another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

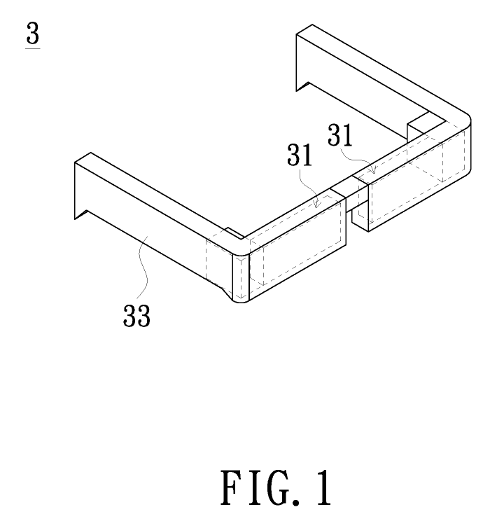

FIG. 1 is a schematic view of a wearable apparatus in accordance with an embodiment of the invention. Please refer to FIG. 1. The wearable apparatus 3 of the embodiment includes at least one imaging assembly 31; wherein FIG. 1 is exemplified by two, for example, imaging assemblies 31, but the number of imaging assemblies is not limited in the invention. In the embodiment, the wearable apparatus 3 may further include a wearing frame body 33, and the imaging assembly 31 is disposed at the wearing frame body 33. In the embodiment, the wearing frame body 33 is, for example, worn on the user's head so that the images provided by the two imaging assemblies 31 in FIG. 1 may be viewed by the eyes of the user respectively. The specific structure of the wearing frame body is not limited in the invention.

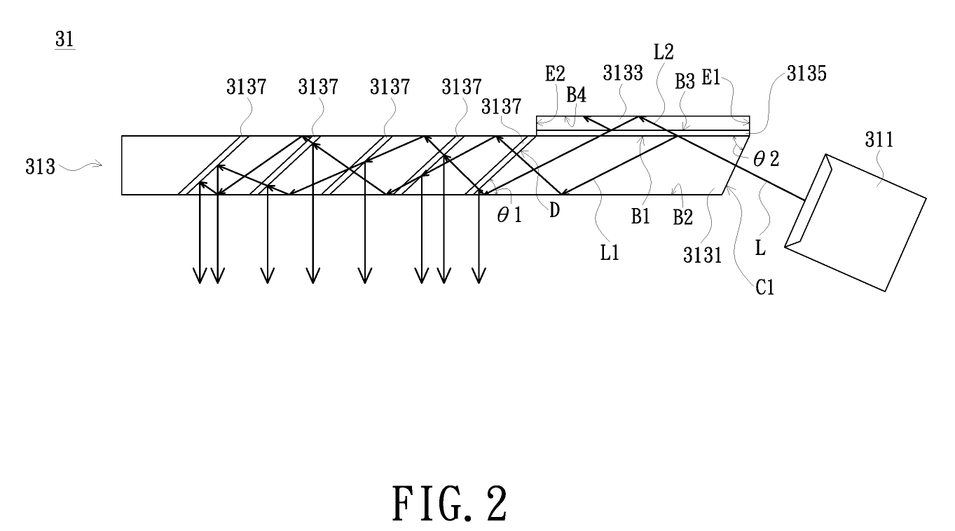

The imaging assembly 31 will be exemplarily described in the following embodiments. FIG. 2 is a schematic view of an imaging assembly in accordance with an embodiment of the invention. Please refer to FIG. 2. The imaging assembly 31 includes a display apparatus 311 and a light guide element 313. In the embodiment, the display apparatus 311 is adapted to provide an image light beam L, and the light guide element 313 is adapted to guide the image light beam L so that the eyes of the user may receive the image light beam L. In the embodiment, the display apparatus 311 may be a projection optical engine, a projection unit or other types of display apparatus. The projection optical engine/projection unit may use a transmissive light valve (e.g., a transmissive liquid crystal display panel), a reflective light valve (e.g., a liquid crystal on silicon panel or a digital micromirror device) or a self-luminous display panel (e.g., an organic light emitting diode display panel), but the invention is not limited thereto.

The light guide element 313 includes a first light guide plate 3131, a second light guide plate 3133, a light splitting film 3135, and a plurality of light splitting elements 3137. In the embodiment, the first light guide plate 3131 and the second light guide plate 3133 are, for example, waveguide elements and may be made of light-permeable material, but the invention is not limited thereto. The first light guide plate 3131 has a first surface B1, a second surface B2, and the second surface B2. The second surface B2 is opposite to the first surface B1, and the light entrance surface C1 is connected between the first surface B1 and the second surface B2; wherein the light entrance surface C1 is adapted to allow the image light beam L to pass through. The second light guide plate 3133 is disposed on a part of the first surface B1 of the first light guide plate 3131, and is located on the transmission path of the image light beam L. The light splitting film 3135 is disposed between the second light guide plate 3133 and a part of the first surface B1 of the first light guide plate 3131, and is adjacent to the light entrance surface C1. The light splitting film 3135 is adapted to reflect a portion of the image light beam L, and allow at least a portion of the image light beam L from a part of the first surface B1 of the first light guide plate 3131 to pass to the second light guide plate 3133. In addition, the plurality of light splitting elements 3137 are intervally disposed in a region of the first light guide plate 3131 that is not covered with the light splitting film 3135, and each of the light splitting elements 3137 is connected between the first surface B1 and the second surface B2. A first acute angle θ1 is formed between the second surface B2 and a surface D of each of the light splitting elements 3137 facing the light entrance surface C1. Each of the light splitting elements 3137 is adapted to allow a portion of the image light beam L to pass through and reflect a portion of the image light beam L, and the image light beam L is adapted to emit out from the second surface B2 via the reflection of the light splitting elements 3137. In the embodiment, the user's eyes may view the image by receiving the image light beam L emitted from the second surface B2 of the first light guide plate 3131.

In the embodiment, the second light guide plate 3133 covers the light splitting film 3135, but the invention is not limited thereto. In the embodiment, the first light guide plate 3131 and the second light guide plate 3133 may be made of plastic, glass, acrylic, or other light-permeable material, but the invention is not limited thereto. In the embodiment, the light entrance surface C1 of the first light guide plate 3131 is inclined, for example, with respect to the first surface B1, and a second acute angle θ2 is formed between the light entrance surface C1 and the first surface B1. In the embodiment, the angle of the second acute angle θ2 is, for example, twice the angle of the first acute angle θ1 (double of the first acute angle θ1). For example, the angle of the first acute angle θ1 is 30 degrees, and the angle of the second acute angle θ2 is 60 degrees. However, the angle of the second acute angle θ2 may be adjusted depending on the incident path of the image light beam L, and is not limited to 60 degrees.

The second light guide plate 3133 has, for example, a third surface B3 and a fourth surface B4, and the fourth surface B4 is opposite to the third surface B3. In the embodiment, the third surface B3 is connected to the light splitting film 3135; and the first surface B1, the second surface B2, the fourth surface B4, and the light splitting film 3135 are, for example, parallel to each other. In the embodiment, the third surface B3 is parallel to the first surface B1, the second surface B2, and the fourth surface B4. In other embodiments, depending on the different design requirements, at least a part of the first surface B1, at least a part of the second surface B2, at least a part of the fourth surface B4 and/or at least a part of the light splitting film 3135 may not be parallel to each other, thereby adjusting the transmission path of the image light beam L. In the embodiment, the second light guide plate 3133 further has, for example, a first side surface E1 and a second side surface E2, the second side surface E2 is opposite to the first side surface E1, and the first side surface E1 and the second side surface E2 are connected between the third surface B3 and the fourth surface B4. In the embodiment, the first side surface E1 is adjacent to the light entrance surface C1, and the second side surface E2 is away from the light entrance surface C1. In addition, the first side surface E1 and the second side surface E2 are, for example, parallel to each other, and the first side surface E1 and the second side surface E2 are, for example, perpendicular to the third surface B3 and the fourth surface B4, but the invention is not limited thereto. However, in other embodiments, the first side surface E1 may not be parallel to the second side surface E2 to achieve the effect that the light beam would not pass through the first side surface E1 and the second side surface E2, but the invention is not limited thereto.

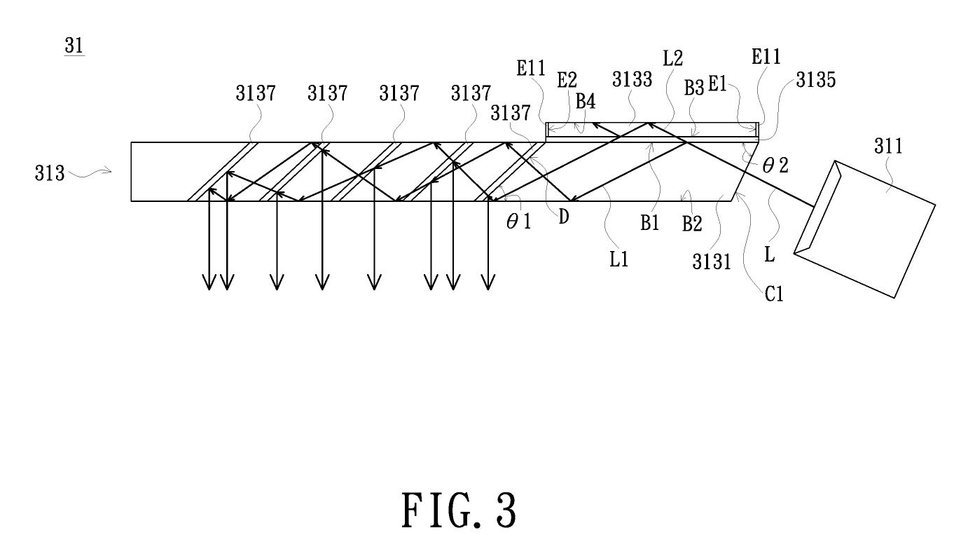

FIG. 3 is a schematic view of an imaging assembly in accordance with another embodiment of the invention. In the embodiment, each of the first side surface E1 and the second side surface E2 of the second light guide plate 3133 may have an anti-light-permeable structure E11. In the embodiment, the anti-light-permeable structure E11 may be formed by way of atomizing the first side surface E1 and the second side surface E2. In other embodiments, the anti-light-permeable structure E11 may be formed by way of coating the first side surface E1 and the second side surface E2 with a light-shielding layer or other proper ways; wherein the light-shielding layer may be a black substance or a black tape. However, the anti-light-permeable structure of the invention is not limited to the above-described forming ways. In the embodiment, the anti-light-permeable structure E11 may avoid light leakage due to the image light beam L in the second light guide plate 3133 being leaked from the first side surface E1 and the second side surface E2, and also prevent the external ambient light from entering into the second light guide plate 3133 from the first side surface E1 and the second side surface E2.

Please refer to FIGS. 2 and 3 together. In the embodiment, the light splitting film 3135 is, for example, a half mirror capable of reflecting a portion of light beam and allowing a portion of light beam to pass through. In the embodiment, the light splitting film 3135 may be formed between the first light guide plate 3131 and the second light guide plate 3133 by way of coating; however, the way of forming the light splitting film is not limited in the invention. In the embodiment, the light splitting film 3135 has a characteristic for allowing a portion of light beam to be reflected and a portion of light beam to pass through. In the embodiment, the light transmittance of the light splitting film 3135 is 20% to 80% and the light reflectance of the light splitting film 3135 is 80% to 20%. Specifically, in an ideal condition (e.g., without considering the light loss), the light splitting film 3135 may have an optical characteristic with a light transmittance of 20% and a light reflectance of 80% in an embodiment; the light splitting film 3135 may have an optical characteristic with a light transmittance of 50% and a light reflectance of 50% in an embodiment; and the light splitting film 3135 may have an optical characteristic with a light transmittance of 80% and a light reflectance of 20% in an embodiment.

In the embodiment, the light splitting elements 3137 are, for example, a light splitting element array in parallel to each other arranged in a region of the first light guide plate 3131 that is not covered with the light splitting film 3135. In the embodiment, in order to make the image light beam L reflected by the light splitting elements 3137 and then emitted out from the second surface B2 have a uniform light intensity, the light splitting element 3137 closer to the light entrance surface C1 is designed to have a higher light transmittance and a lower light reflectance; and on the contrary, the light splitting element 3137 away from the light entrance surface C1 is designed to have a higher light reflectance and a lower light transmittance. In other embodiments, the light splitting element 3137 farthest from the light entrance surface C1 may be an optical element having a high light reflectance, and may even be a reflective element.

In the embodiment, when the image light beam L entering into the first light guide plate 3131 from the light entrance surface C1 is transmitted to the light splitting film 3135, the light splitting film 3135 reflects a portion of the image light beam L (e.g., the light beam L1), and a portion of the image light beam L (e.g., the light beam L2) passes through the light splitting film 3135 and enters the third surface B3 of the second light guide plate 3133. In the embodiment, a portion of the image light beam L in the second light guide plate 3133 (e.g., the light beam L2) is totally reflected on the fourth surface B4 and is sequentially transmitted to the third surface B3 and the light splitting film 3135; wherein a portion of the light beam transmitted to the light splitting film 3135 passes through the light splitting film 3135 and returns into the first light guide plate 3131. Every time when the image light beam L entering into the light guide element 313 is transmitted to the light splitting film 3135, the image light beam L is partially reflected and partially passes through; thus, the image light beam L has a plurality of transmission paths and therefore has the effect of light widening, and accordingly the image light beam L transmitted to the light splitting elements 3137 may be more completely incident on the light receiving surface (i.e., the surface D facing the light entrance surface C1) of the light splitting elements 3137. As a result, the problem that the image light beam emerging from the second surface of the conventional light guide element has a bright-dark streak may be solved or improved, thereby improving the imaging quality.

The imaging assembly 31 of the embodiment may be applied to a virtual reality (VR) device or an augmented reality (AR) device. In an embodiment applied to the virtual reality, the light guide element 313 may further be provided with a light-shielding layer (not shown) to shield a part of the first surface B1 of the first light guide plate 3131 that is not covered with the light splitting film 3135 (e.g., the part of the first surface B1 corresponding to the light splitting elements 3137), thereby preventing the ambient light from entering into the eyes of the user. In one embodiment applied to the see-through augmented reality, the light reflectance of each of the light splitting elements 3137 is preferably not higher than 50%.

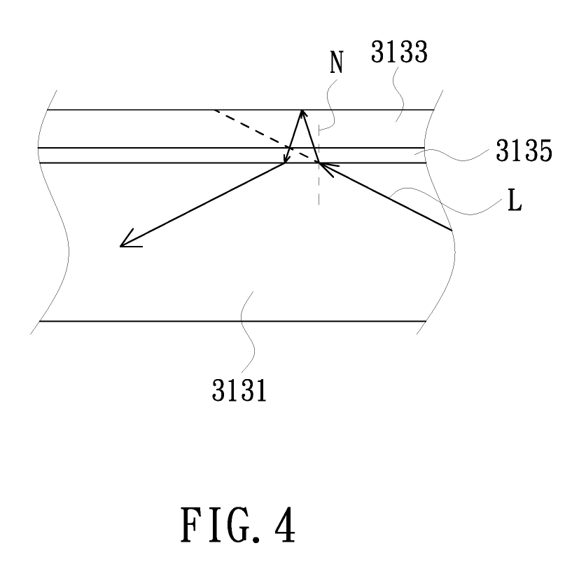

The refractive index of the first light guide plate 3131 and the refractive index of the second light guide plate 3133 may be the same as or different from each other, and will be described in the following embodiment. FIG. 4 is a schematic view of an image light beam travelling in a first light guide plate, a second light guide plate, and a light splitting film in accordance with an embodiment of the invention. Please refer to FIG. 4. In the embodiment, the refractive index of the first light guide plate 3131 is, for example, smaller than the refractive index of the second light guide plate 3133, so that the image light beam L is refracted in a direction toward the normal direction N when entering into the second light guide plate 3133, thereby increasing the number of times the image light beam L transmitted to the light splitting film 3135, and thereby enhancing the diffusion effect of the image light beam L and further improving or solving the problem that the imaging of the conventional light guide element has a bright-dark streak. In an embodiment, the refractive index of the first light guide plate 3131 is, for example, 1.62 to 1.75, the refractive index of the second light guide plate 3133 is, for example, 1.7 to 1.82; wherein the refractive index of the first light guide plate 3131 is, for example, smaller than the refractive index of the second light guide plate 3133, but the invention is not limited thereto. In other embodiments, the refractive index of the first light guide plate 3131 may be greater than the refractive index of the second light guide plate 3133, but the invention is not limited thereto.

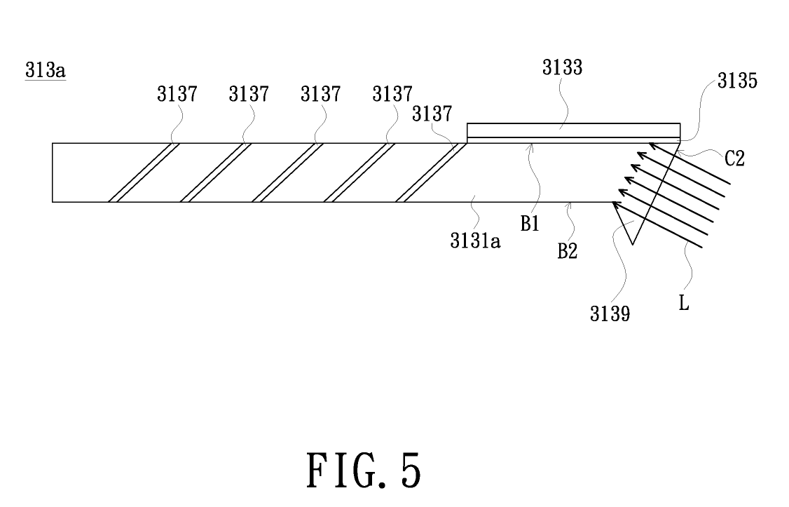

FIG. 5 is a schematic view of a light guide element in accordance with an embodiment of the invention. Please refer to FIG. 5. The light guide element 313a of the embodiment is similar to the light guide element 313 of FIG. 2, and the main difference is: the first light guide plate 3131a of the light guide element 313a has a triangular cylinder protrusion structure 3139 protruding from the second surface B2. The triangular cylinder protrusion structure 3139 is adjacent to the light entrance surface C2. In the embodiment, the light entrance surface C2 extends to, for example, the top of the t triangular cylinder protrusion structure 3139, so that the area of the light entrance surface C2 may be increased. Thus, the irradiation area of the image light beam L entering into the light entrance surface C2 may be increased, the filling ratio of the receiving surface of each light splitting element 3137 may be increased, and the problem that the imaging of the conventional light guide element having a bright-dark streak may be further improved or solved. In addition, the light guide element 313a of the embodiment may be also applied to the imaging assembly 31 of FIG. 2 to replace the light guide element 313 of FIG. 2.

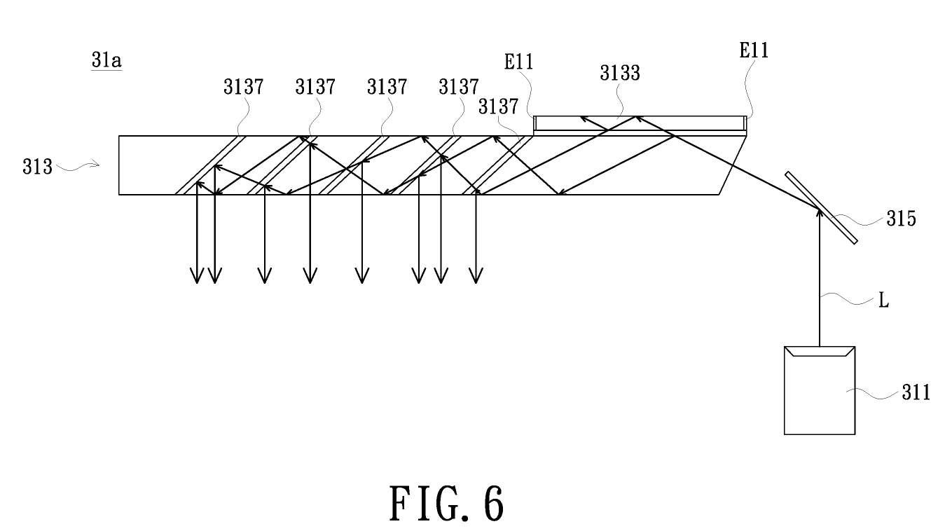

FIG. 6 is a schematic view of an imaging assembly in accordance with another embodiment of the invention. Please refer to FIG. 6. The imaging assembly 31a of the embodiment is similar to the imaging assembly 31 of FIG. 3, and the main difference is: the imaging assembly 31a of the embodiment further includes a reflective element 315. In the embodiment, the reflective element 315 is disposed between the display apparatus 311 and the light guide element 313, and is adapted to reflect the image light beam L from the display apparatus 311 to the light entrance surface C1 of the light guide element 313 as shown in FIG. 3. Further, the light guide element 313 of the embodiment may be replaced by the light guide element 313a of FIG. 5.

In summary, in the light guide element according to the embodiment of the invention, the second light guide plate adjacent to the light entrance surface is additionally disposed on the first light guide plate, and the light splitting film is disposed between the first light guide plate and the second light guide plate; therefore, in the light beam (e.g., an image light beam) entering into the light guide element, a portion of the image light beam may be reflected in the first light guide plate and a portion of the image light beam may pass through the first light guide plate and the light splitting film to enter into the second light guide plate and may be then reflected back into the first light guide plate via the second light guide plate. Due to the increased number of transmission path(s) of the image light beam, the filling ratio of the light receiving surface of the light splitting elements may be increased when the image light beam is transmitted to the light splitting elements; thus, the problem that the imaging of the prior art has a uneven image brightness due to bright-dark streaks is improved or solved. The wearable apparatus having the light guide element of the embodiment of the invention may improve the problem of uneven image brightness of the prior art. Further, in the embodiment of the invention, because the triangular cylinder protrusion structure is additionally disposed on the second surface of the first light guide plate and adjacent to the light entrance surface, the area of the light entrance surface is increased, the filling ratio of the light receiving surface of the light splitting elements is increased, and therefore the problem of bright-dark streaks is further improved or solved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

1. A wearable apparatus, comprising:
at least one imaging assembly, and the imaging assembly comprising:
a display apparatus, adapted to provide an image light beam; and
a light guide element, adapted to guide the image light beam, and the light guide element comprising:
a first light guide plate, having a first surface, a second surface, and a light entrance surface, wherein the second surface is opposite to the first surface, the light entrance surface is connected between the first surface and the second surface, and the light entrance surface is adapted to allow the image light beam to pass through;
a second light guide plate, disposed on a part of the first surface of the first light guide plate, and located on a transmission path of the image light beam; and
a light splitting film, disposed between the second light guide plate and a part of the first surface of the first light guide plate, and adjacent to the light entrance surface, wherein the light splitting film is adapted to reflect a portion of the image light beam, and is adapted to allow at least a portion of the image light beam from a part of the first surface of the first light guide plate to pass to the second light guide plate.

2. The wearable apparatus according to claim 1, wherein the second light guide plate has a third surface and a fourth surface, the fourth surface is opposite to the third surface, the third surface is connected to the light splitting film, and the first surface, the second surface, the fourth surface, and the light splitting film are parallel to each other.

3. The wearable apparatus according to claim 1, wherein the second light guide plate has a third surface and a fourth surface, the fourth surface is opposite to the third surface, the third surface is connected to the light splitting film, and the fourth surface is adapted to reflect at least a portion of the image light beam.

4. The wearable apparatus according to claim 1, wherein the second light guide plate has a third surface, a fourth surface, a first side surface, and a second side surface, the fourth surface is opposite to the third surface, the second side surface is opposite to the first side surface, the third surface is connected to the light splitting film, the first side surface and the second side surface are connected between the third surface and the fourth surface, and the first side surface is adjacent to the light entrance surface.

5. The wearable apparatus according to claim 1, wherein the second light guide plate has a third surface, a fourth surface, a first side surface, and a second side surface, the fourth surface is opposite to the third surface, the second side surface is opposite to the first side surface, the third surface is connected to the light splitting film, the first side surface and the second side surface are connected between the third surface and the fourth surface, and both of the first side surface and the second side surface have an anti-light-permeable structure.

6. The wearable apparatus according to claim 1, wherein a refractive index of the first light guide plate and a refractive index of the second light guide plate is the same as or different from each other.

7. The wearable apparatus according to claim 1, wherein a refractive index of the first light guide plate is smaller than a refractive index of the second light guide plate.

8. The wearable apparatus according to claim 1, wherein a light transmittance of the light splitting film is 20% to 80%.

9. The wearable apparatus according to claim 1, wherein a light reflectance of the light splitting film is 80% to 20%.

10. The wearable apparatus according to claim 28, wherein the light entrance surface is inclined with respect to the first surface, and a second acute angle is formed between the light entrance surface and the first surface.

11. The wearable apparatus according to claim 10, wherein an angle of the second acute angle is twice an angle of the first acute angle.

12. The wearable apparatus according to claim 1, wherein the first light guide plate has a triangular cylinder protrusion structure protruding from the second surface, and the triangular cylinder protrusion structure is adjacent to the light entrance surface.

13. The wearable apparatus according to claim 1, wherein the imaging assembly further comprises a reflective element, the reflective element is disposed between the display apparatus and the light guiding element, and is adapted to reflect the image light beam from the display apparatus to the light entrance surface of the light guide element.

14. The wearable apparatus according to claim 13, further comprising a wearing frame body, wherein a number of the at least one imaging assembly is two, and the imaging assemblies are disposed at the wearing frame body.

15. A light guide element, adapted to guide a light beam, and the light guide element comprising:
a first light guide plate, having a first surface, a second surface, and a light entrance surface, wherein the second surface is opposite to the first surface, the light entrance surface is connected between the first surface and the second surface, and the light entrance surface is adapted to allow the light beam to pass through;
a second light guide plate, disposed on a part of the first surface of the first light guide plate, and located on a transmission path of the light beam; and
a light splitting film, disposed between the second light guide plate and a part of the first surface of the first light guide plate, and adjacent to the light entrance surface, wherein the light splitting film is adapted to reflect a portion of the light beam, and is adapted to allow at least a portion of the light beam from a part of the first surface of the first light guide plate to pass to the second light guide plate.

16. The light guide element according to claim 15, wherein the second light guide plate has a third surface and a fourth surface, the fourth surface is opposite to the third surface, the third surface is connected to the light splitting film, and the first surface, the second surface, the fourth surface, and the light splitting film are parallel to each other.

17. The light guide element according to claim 15, wherein the second light guide plate has a third surface and a fourth surface, the fourth surface is opposite to the third surface, the third surface is connected to the light splitting film, and the fourth surface is adapted to reflect at least a portion of the image light beam.

18. The light guide element according to claim 15, wherein the second light guide plate has a third surface, a fourth surface, a first side surface, and a second side surface, the fourth surface is opposite to the third surface, the second side surface is opposite to the first side surface, the third surface is connected to the light splitting film, the first side surface and the second side surface are connected between the third surface and the fourth surface, and the first side surface is adjacent to the light entrance surface.

19. The light guide element according to claim 15, wherein the second light guide plate has a third surface, a fourth surface, a first side surface, and a second side surface, the fourth surface is opposite to the third surface, the second side surface is opposite to the first side surface, the third surface is connected to the light splitting film, the first side surface and the second side surface are connected between the third surface and the fourth surface, and both of the first side surface and the second side surface have an anti-light-permeable structure.

20. The light guide element according to claim 15, wherein a refractive index of the first light guide plate and a refractive index of the second light guide plate is the same as or different from each other.

21. The light guide element according to claim 15, wherein a refractive index of the first light guide plate is smaller than a refractive index of the second light guide plate.

22. The light guide element according to claim 15, wherein a light transmittance of the light splitting film is 20% to 80%.

23. The light guide element according to claim 15, wherein a light reflectance of the light splitting film is 80% to 20%.

24. The light guide element according to claim 29, wherein the light entrance surface is inclined with respect to the first surface, and a second acute angle is formed between the light entrance surface and the first surface.

25. The light guide element according to claim 24, wherein an angle of the second acute angle is twice an angle of the first acute angle.

26. The light guide element according to claim 15, wherein the first light guide plate has a triangular cylinder protrusion structure protruding from the second surface, and the triangular cylinder protrusion structure is adjacent to the light entrance surface.

27. The light guide element according to claim 15, wherein among the light splitting elements, the light splitting element closer to the light entrance surface has a higher light transmittance.

28. The wearable apparatus according to claim 1, wherein the light guide element further comprises a plurality of light splitting elements, intervally disposed in a region of the first light guide plate not being covered with the light splitting film, wherein each of the light splitting elements is connected between the first surface and the second surface, and a first acute angle is formed between the second surface and a surface of each of the light splitting elements facing the light entrance surface, wherein each of the light splitting elements is adapted to allow a portion of the image light beam to pass through and reflect a portion of the image light beam, and the image light beam is adapted to emit out from the second surface via reflection of the light splitting elements.

29. The light guide element according to claim 15, further comprising a plurality of light splitting elements, intervally disposed in a region of the first light guide plate not being covered with the light splitting film, wherein each of the light splitting elements is connected between the first surface and the second surface, and a first acute angle is formed between the second surface and a surface of each of the light splitting elements facing the light entrance surface, wherein each of the light splitting elements is adapted to allow a portion of the light beam to pass through and reflect a portion of the light beam, and the light beam is adapted to emit out from the second surface via reflection of the light splitting elements.
